(19) United States
(12) Patent Application Publication
(10) Pub. No.: US 2011/0198238 A1
(43) Pub. Date: Aug. 18, 2011

(54) ELECTRODE FOR ELECTROCHEMICAL WATER TREATMENT, METHOD OF MANUFACTURING THE SAME, METHOD OF TREATING WATER USING THE ELECTRODE, AND DEVICE INCLUDING THE ELECTRODE FOR ELECTROCHEMICAL WATER TREATMENT

(75) Inventors: Joo-wook LEE, Seoul (KR); Hyo-rang KANG, Anyang-si (KR); Jae-young KIM, Suwon-si (KR); Jae-eun KIM, Seoul (KR)

(73) Assignee: SAMSUNG ELECTRONICS CO., LTD., Suwon-si (KR)

(21) Appl. No.: 12/879,065

(22) Filed: Sep. 10, 2010

(30) Foreign Application Priority Data
Feb. 18, 2010 (KR) 10-2010-0014730

(51) Int. Cl. C25B 11/04; C02F 1/461; C25B 11/12; C25B 9/00; B05D 5/12

(52) U.S. Cl. 205/760; 205/742; 204/291; 204/292; 204/294; 204/293; 204/284; 204/194; 427/122; 977/932

(57) ABSTRACT

An electrode for electrochemical water treatment, the electrode including a nanodiamond and a conducting agent.

### CROSS-REFERENCE TO RELATED APPLICATIONS

This application claims priority to Korean Patent Application No. 10-2010-0014730, filed on Feb. 18, 2010, and all the benefits accruing therefrom under 35 U.S.C. §119, the content of which in its entirety is herein incorporated by reference.

### BACKGROUND

1. Field

The present disclosure relates to an electrode for electrochemical water treatment, a method of treating water using the electrode, and a device including the electrode for electrochemical water treatment.

2. Description of the Related Art

Recently, diverse research has been conducted on thin boron-doped diamond (“BDD”) electrodes for water treatment. A BDD electrode may be prepared by forming a diamond thin film on a substrate, such as a conductive silicon wafer, a titanium plate, or a molybdenum plate, using a chemical vapor deposition (“CVD”)method. In the CVD method, methane is typically used as a carbon source. A pure diamond thin film is a semiconductor having a band gap of about 5.2 electron volts (eV), and thus is an insulator. However, when a boron source, such as BO₂, is added to a CVD deposition material during a CVD process, a conductive boron-doped diamond thin film may be provided. In this regard, as the amount of boron doped in the diamond thin film increases, the conductivity of the diamond thin film also increases. Generally, about 1000 parts per million (ppm) by weight of boron provides a diamond thin film with sufficient conductivity so that it may be considered a conductor. The term conductor being understood by one of ordinary skill in the art to refer to a material exhibiting significant electricity therethrough and the term insulator being understood by one of ordinary skill in the art to refer to a material which prevents significant electrical flow therethrough.

Such BDD electrodes may be applied to an electrochemical analysis (e.g., used as a sensor), electrochemical waste water treatment, electrochemical water purification, or the like, and can provide improved performance relative to current technologies.

BDD electrodes are suitable for electrochemical water treatment devices to which a high voltage is applied due to their wide potential window and high oxygen evolution overvoltage. In other words, if water is electrochemically treated by electrolysis using a BDD electrode, which has a higher oxygen evolution overvoltage than an alternative electrode, waste of energy used for electrolyzing water may be substantially prevented or effectively reduced.

Electrochemical sterilization may be conducted by supplying electric power to an electrolysis sterilization device while flowing water between two electrodes of the electrolysis sterilization device, in which the electrodes have opposite polarity. In the electrolysis sterilization device, water electrolysis takes place and an oxidant is generated by a potential difference formed between the two electrodes. If a microorganism is present in the water, the oxidant effectively destroys the microorganism, thereby sterilizing the water. In the treated (e.g., sterilized) water, a variety of oxidants, for example, a reactive oxygen species (“ROS”), such as a hydroxyl radical (OH.), hydrogen peroxide (H₂O₂), ozone (O₃), an ionic species, and a radical species having a sterilizing effect such as a hypochlorite ion (OCl⁻), or chlorine (Cl₂), may be generated. Generally, an oxidation potential of such an oxidant is equal to or greater than 1.80 V, which is 0.5 V greater than a potential for water electrolysis, which is 1.23 V. Accordingly, if an electrode having a low oxygen evolution overvoltage is used, a larger fraction of the energy is consumed for electrolyzing water, and thus the amount and yield of the oxidants may decrease. On the other hand, if an electrode having a high oxygen evolution overvoltage is used, the energy consumed for electrolyzing water decreases, and thus the amount and yield of the oxidants may increase.

However, BDD electrodes are not typically used despite these advantages because the practical cost of manufacturing a BDD electrode is high for at least the reason that commercially available BDD electrodes are manufactured using an energy intensive CVD process, and it is difficult to manufacture a large-sized electrode because the size of the electrode is limited by the dimensions of a CVD vacuum chamber.

Thus there remains a need for a BDD electrode having a reduced manufacturing cost, which is suitable for water treatment.

### SUMMARY

Provided is an electrode for electrochemical water treatment which includes a nanodiamond.

Provided is a device for electrochemical water treatment including the electrode.

Additional aspects will be set forth in part in the description which follows and, in part, will be apparent from the description.

According to an aspect, an electrode for electrochemical water treatment includes a nanodiamond; and a conducting agent.

The nanodiamond may have an average particle size equal to or less than about 10 nanometers (nm).

The conducting agent may include at least one of carbon black or metallic powder.

The metallic powder may include at least one of chromium (Cr), tungsten (W), nickel (Ni), molybdenum (Mo), TiN, CrN, WN, NiN, MoN, TiC, CrC, WC, NiC, MoC, TiO, CrO, WO, NiO, or MoO.

The amount of the conducting agent may be about 10 weight percent to about 50 weight percent, based on the total weight of the nanodiamond and the conducting agent.

The amount of the conducting agent may be about 10 weight percent to about 50 weight percent, based on the total weight of the electrode.

The electrode may have a water-permeable three-dimensional structure.

An active area of the electrode may be greater than a geometric surface area of the electrode.

An active area of the electrode may be about 30 times greater than a geometric surface area of the electrode.

The electrode may further include a binder.

The binder may include at least one of polyvinylidene fluoride (“PVDF”), styrene butadiene rubber (“SBR”), carboxymethylcellulose (“CMC”), or polytetrafluoroethlyene (“PTFE”).

According to another aspect, a device for electrochemical water treatment includes at least one electrode for electrochemical water treatment.

Also disclosed is a method of manufacturing an electrode. The method includes detonating diamond to form nanodiamond; and contacting the nanodiamond with a conducting agent to provide the electrode.

The nanodiamond may have an average particle size of equal to or less than about 100 nanometers.

Also disclosed is a method of treating water. The method includes contacting an electrode and water, wherein the electrode includes a nanodiamond, and a conducting agent.

In an embodiment, the nanodiamond may be ultra-dispersed-detonation diamond.

### BRIEF DESCRIPTION OF THE DRAWING

These and/or other aspects will become apparent and more readily appreciated from the following description of the embodiments, taken in conjunction with the accompanying drawing in which:

FIG. 1 schematically shows an embodiment of a device for electrochemical water treatment, the device including an electrode for electrochemical water treatment.

### DETAILED DESCRIPTION

Reference will now be made in detail to embodiments, examples of which are illustrated in the accompanying drawings, wherein like reference numerals refer to the like elements throughout. In this regard, the present embodiments may have different forms and should not be construed as being limited to the descriptions set forth herein. Accordingly, the embodiments are merely described below, by referring to the figures, to explain aspects of the present description.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting. As used herein, the singular forms “a,” “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

An embodiment of an electrode for electrochemical water treatment according to the present disclosure will be disclosed in further detail.

The electrode for electrochemical water treatment includes a nanodiamond and a conducting agent. The term “nanodiamond” as used herein refers to a diamond having a particle size on the scale of several to several hundreds of nanometers only.

For example, the nanodiamond may have an average (e.g., average longest dimension) particle size of equal to or less than 100 nanometers (nm), 80 nm, 60 nm, 40 nm, 30 nm, or 10 nm. In an embodiment, the nanodiamond may have an average (e.g., average longest) particle size of about 0.01 nm to about 100 nm, specifically about 0.1 nm to 80 nm, more specifically about 1 nm to about 60 nm. The conductivity of the nanodiamond increases as the average particle size of the nanodiamond decreases. Thus, when a nanodiamond having a smaller average particle size is used, the same conductivity may be obtained by reducing the amount of the conducting agent. Alternatively, the conductivity of the nanodiamond is reduced as the average particle size of the nanodiamond increases. Thus, when a nanodiamond having a larger average particle size is used, the amount of the conducting agent in the electrode may be increased to provide the desired conductivity. Accordingly, characteristics of the nanodiamond may deteriorate and characteristics of the conductive agent may be increased.

The nanodiamond may be prepared by a method which includes pulverization, detonation, or the like, and the cost of detonation may be less than the cost of pulverization. A nanodiamond that is prepared using detonation is referred to as an ultra-dispersed-detonation diamond (“UDD”).

The conducting agent may include at least one of carbon black or metallic powder.

The metallic powder may include at least one of chromium (Cr), tungsten (W), nickel (Ni), molybdenum (Mo), TiN, CrN, WN, NiN, MoN, TiC, CrC, WC, NiC, MoC, TiO, CrO, WO, NiO, or MoO.

The amount of the conducting agent may be about 10 weight percent (wt %) to about 50 wt %, specifically 15 wt % to 45 wt %, more specifically 20 wt % to 40 wt %, based on the total weight of the nanodiamond and the conducting agent. If the amount of the conducting agent is within the foregoing range, the electrode may have sufficient conductivity, a sufficiently wide potential window, and high oxygen evolution overvoltage.

The amount of the conducting agent may be about 10 weight percent (wt %) to about 50 wt %, specifically 15 wt % to 45 wt %, more specifically 20 wt % to 40 wt %, based on the total weight of the electrode. If the amount of the conducting agent is within the foregoing range, the electrode may have sufficient conductivity, a sufficiently wide potential window, and high oxygen evolution overvoltage.

The electrode for electrochemical water treatment may have a water-permeable three-dimensional structure. Thus, water to be treated may contact the outer surface of the electrode and permeate inside the electrode and contact the inner surface of the electrode. Accordingly, an active area of the electrode may be greater than a geometric surface area thereof. For example, in one embodiment the active area of the electrode may be at least about 10 times greater than a geometric surface area of the electrode. In another embodiment, the active area of the electrode may be at least about 20 times greater than a geometric surface area of the electrode. In another embodiment, the active area of the electrode may be at least about 30 times greater than a geometric surface area of the electrode. In another embodiment, the active area of the electrode may be at least about 50 times greater than a geometric surface area of the electrode. In another embodiment, the active area of the electrode may be at least about 70 times greater than a geometric surface area of the electrode. In another embodiment, the active area of the electrode may be at least about 100 times greater than a geometric surface area of the electrode.

In an embodiment, the active area of the electrode is about 1 time to about 100 times a geometric surface area of the electrode. Specifically, in one embodiment, the active area of the electrode is about 10 times to about 90 times a geometric surface area of the electrode. In another embodiment, the active area of the electrode is about 20 times to about 80 times a geometric surface area of the electrode. When the active area of the electrode is greater than the geometric surface area thereof, the water treatment capability of the electrode is improved. As used herein, the term “active area” refers to the total area of the electrode involved in an electrochemical reaction (e.g., an electrochemically active area), and the term “geometric surface area” refers to a two-dimensional outer surface area of the electrode, i.e., the surface area of a smooth surface of one side of the electrode. The active area increases as the permeability and conductivity of the electrode increases.

The electrode for electrochemical water treatment may further include a binder.

The binder may bind materials of the electrode, such as the nanodiamond and the conducting agent. The binder may include at least one of polyvinylidene fluoride (“PVDF”), styrene butadiene rubber (“SBR”), carboxymethylcellulose (“CMC”), or polytetrafluoroethlyene (“PTFE”) and other materials with similar characteristics.

When an electrical current is supplied to the electrode for electrochemical water treatment having the structure as disclosed above, an organic material contained in the water to be treated may be oxidized (e.g., decomposed) to form a low molecular weight compound by the contact with the electrode, water may be electrolyzed to generate at least one of a hydroxyl radical (e.g., (OH.), ozone, or hydrogen peroxide, and a microorganism, which may be contained in the water to be treated, may be oxidized (e.g., decomposed or destroyed) and thus killed by the contact with the electrode and/or with at least one of a hydroxyl radical (e.g., (OH.), ozone, or hydrogen peroxide, for example. In water to be treated which contains chlorine, a chloride ion (Cl⁻) may be oxidized to form a hypochlorite ion (ClO⁻). In addition, an organic material, a microorganism, or the like, which may be contained in water to be treated, may further be oxidized (e.g., decomposed) by the ozone, hydrogen peroxide, hypochlorite ion, or hydroxyl radical, for example. Furthermore, the electrode for electrochemical water treatment may have a sufficiently wide potential window and a sufficiently high oxygen evolution overvoltage, which are characteristics of diamond. Accordingly, when water is electrochemically treated as disclosed herein, the waste of energy, which may occur from oxygen evolution, may be substantially prevented or effectively reduced, and thus energy efficiency may be improved.

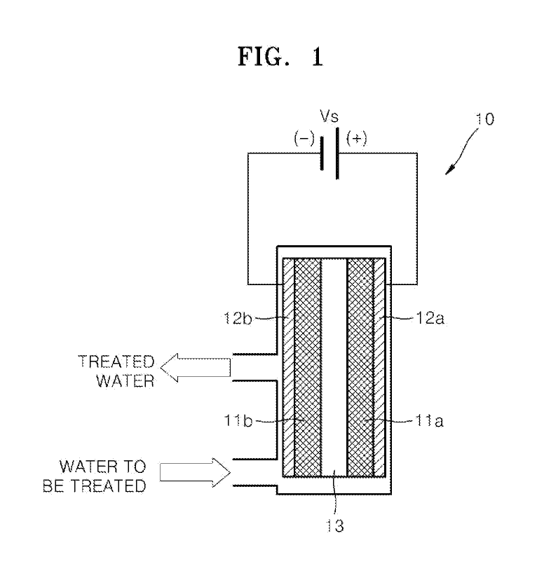

Hereinafter, a device 10 including the electrode for electrochemical water treatment will be described in detail with reference to FIG. 1.

Referring to FIG. 1, the device 10 for electrochemical water treatment includes an oxidation electrode 11a, a reduction electrode 11b, a first current collector 12a, a second current collector 12b, and a separator 13. In addition, a fluid channel, through which water to be treated may flow, is disposed between the oxidation electrode 11a and the reduction electrode 11b. If the oxidation electrode 11a and the reduction electrode 11b have a water-permeable three-dimensional structure, water to be treated may flow through the fluid channel and may also permeate inside the oxidation electrode 11a and the reduction electrode 11b.

The oxidation electrode 11a and the reduction electrode 11b may be disposed to be opposite to and separated from each other with the separator 13 therebetween.

In addition, at least one of the oxidation electrode 11a and the reduction electrode 11b may be the electrode for electrochemical water treatment as further disclosed above. For example, the oxidation electrode 11a and the reduction electrode 11b may each be the electrode for electrochemical water treatment further disclosed above. Alternatively, the oxidation electrode 11a may be the electrode for electrochemical water treatment and the reduction electrode 11b may be a carbon electrode or a metal electrode, for example. Alternatively, the oxidation electrode 11a may be a carbon electrode or a metal electrode, for example, and the reduction electrode 11b may be the electrode for electrochemical water treatment.

Hereinafter, the operating principle of the device 10 for electrochemical water treatment will be disclosed in further detail with reference to FIG. 1.

First, water to be treated may flow in the fluid channel, which is disposed between the oxidation and reduction electrodes. In an embodiment, the fluid channel may be defined by the separator 13. The water to be treated may include an organic material, a microorganism, and/or a chloride ion.

Then, a voltage is applied between the oxidation electrode 11a and the reduction electrode 11b through the first and second current collectors 12a and 12b, respectively, from a power source Vs, and an oxidation (e.g., oxidation-decomposition or decomposition) reaction may occur at (e.g., m) the oxidation electrode 11a, and a reduction reaction occurs at (e.g., m) the reduction electrode 11b. Thus, in an embodiment, in the oxidation electrode 11a, water is oxidized to produce at least one of oxygen, ozone, hydrogen peroxide, or a hydroxyl radical, and a chloride ion (Cl⁻) (if present) may be oxidized to produce a hypochlorite ion (ClO⁻). Also, an organic material or a microorganism, which contacts the surface of the electrode, or contacts (e.g., reacts with) an electrolysis product such as ozone, hydrogen peroxide, a hypochlorite ion (ClO⁻), or a hydroxyl (e.g., OH) radical, which may be generated by oxidation of water, may be oxidized or decomposed. In addition, a hydrogen ion and/or oxygen are reduced to produce hydrogen, OH⁻ and/or HO₂⁻ at (e.g., in) the reduction electrode 11b.

Treated water (e.g., sterilized water), which may contain the oxidation or decomposition product of an organic material which is oxidized and/or decomposed in the device 10 for electrochemical water treatment, may be discharged out of the device 10 for electrochemical water treatment or circulated in the device 10 for electrochemical water treatment for further treatment.

The device 10 for electrochemical water treatment, which may have the structure further disclosed above, may be applied to a variety of industrial water treatment devices such as a small or a medium size water purification device, a water treatment device for a swimming pool, a water treatment device for a cooling towers, a ballast water treatment device, or a waste water treatment device; a water treatment device for a small household appliance such as a washing machine or a refrigerator; a home water purification device; or a sterilization device for medical equipment, for example.

Hereinafter, an embodiment will be disclosed in further detail with reference to the following examples. However, these examples are not intended to limit the purpose and scope of the one or more embodiments of the disclosure.

### EXAMPLES

### Examples 1 and 2 and Comparative Examples 1 to 3

### Preparation of Electrode and Cell

### 1) Manufacture of Electrode

Nanodiamond powder having an average particle size of 6 nanometers (nm) (LINK Korea Corp., MND), carbon black (Super P or KB300J), 60 weight percent (wt %) polytetrafluoroethylene (“PTFE”) water suspension, and 1,3-propanediol were mixed, and the mixture was kneaded using a kneader to prepare a paste. Then, the paste was stretched using a roll press. Then, the stretched paste was dried in an oven at 80° C. for 2 hours, at 120° C. for 1 hour, and at 200° C. for 1 hour to complete the manufacture of an electrode.

The amounts of the nanodiamond powder, carbon black, 60 wt % PTFE water suspension, and 1,3-propanediol used in Examples 1 and 2 and Comparative Examples 1 to 3 are shown in Table 1 below.

TABLE 1

| | Nano- | | | 60 wt % | |
|---|---|---|---|---|---|
| | diamond | | | PTFE water | 1,3- |
| | powder | Carbon black (g) | | suspension | propanediol |
| | (grams, g) | Super P | KB300J | (g) | (g) |
| Example 1 | 16 | 4 | 0 | 1.66 | 40 |
| Example 2 | 12 | 8 | 0 | 1.66 | 40 |
| Comparative | 20 | 0 | 0 | 1.66 | 40 |
| Example 1 | | | | | |
| Comparative | 0 | 20 | 0 | 1.66 | 40 |
| Example 2 | | | | | |
| Comparative | 0 | 0 | 20 | 1.66 | 40 |
| Example 3 | | | | | |

### 2) Manufacture of Cell

Each of the electrodes, which were dried as disclosed above, was cut into 2 pieces, each having an area of 100 cm² and dimensions of 10 centimeters (cm) by 10 CM.

The two pieces of each electrode were put into distilled water and were vacuum-impregnated.

A cell was prepared by sequentially stacking a current collector (graphite foil), one piece of the vacuum-impregnated electrode, a separator (water-permeable open mesh), the other piece of the vacuum-impregnated electrode, and the current collector (graphite foil).

Pressure was applied to the cell and was adjusted using a torque wrench to assemble the cell, and the torque was increased to 1.5 Newton-meters (N-m).

### EVALUATION EXAMPLES

### Evaluation Example 1

### Cell Performance Evaluation

Free chlorine generating capability and a ratio of the active area to the geometric surface area of each of electrodes prepared according to Examples 1 and 2 and Comparative Examples 1 and 2, a boron-doped diamond (“BDD”) electrode (having an average particle diameter of greater than 10 micrometers (μm), Adamant Technologies) according to Comparative Example 4, and a platinum electrode (Johnson Matthey) according to Comparative Example 5 were measured, and the results are shown in Table 2 below. The free chlorine used herein refers to a chlorine-containing oxidant having a sterilizing effect, such as ClO⁻, HClO, or Cl₂.

### Measurement of Amount of Generated Free Chlorine

The amount of free chlorine was measured using an N,N-Diethyl-p-Phenylenediamine (“DPD”) method. The electrodes prepared according to Examples 1 and 2, and Comparative Examples 1 and 2; and the electrodes of Comparative Examples 4 and 5 were respectively inserted into an electrochemical reactor having an Ag/AgCl reference electrode, a carbon bar counter electrode, and a 10 millimolar (mM) KCl/0.1 molar (M) KH₂PO₄ aqueous electrolyte. Then a voltage in the range of about 4 volts (V) to about 5 V was applied thereto for 5 minutes using a potentiostat (EG&G, PARSTAT 2273). Then, a liquid sample was collected from the electrochemical reactor. Then, a DPD indicator (Hach, DPD Free Chlorine Reagent) was added to the liquid sample, and the amount of free chlorine was measured using a spectrometer (Hach, Colorimeter 890). In this regard, the amount of free chlorine was converted into the amount of Cl₂ parts per million by weight (wtppm), and the results are shown in Table 2 below.

### Active Area to Geometric Surface Area

The Geometric surface area of each electrode was calculated by measuring the length and width of each electrode. The active area of each of the electrodes was also measured using an electrochemical method as disclosed below. That is, the electrodes prepared according to Examples 1 and 2, and Comparative Examples 1 and 2; and the electrodes of Comparative Examples 4 and 5 were each respectively inserted into an electrochemical reactor having a Ag/AgCl reference electrode, a carbon bar counter electrode, and a 1 mM K₄Fe(CN)₆/0.1M KH₂PO₄ aqueous electrolyte, and then a voltage of 0.7 V was applied thereto using a potentiostat (EG&G, PARSTAT 2273). In this regard, the active area of each of the electrodes was calculated using the measured current values by Equation 1 below.

$$\frac{{it}^{1 / 2}}{{C}_{o}^{*}} = \frac{{nFAD}_{O}^{1 / 2} {π}^{1 / 2}}{2} \qquad Equation 1$$

In Equation 1, i is current, t is reaction time, C₀* is initial concentration of K₄Fe(CN)₆, n is the number of electrons involved in the reaction, F is the Faraday constant, A is active area of the electrodes, and D₀ is the diffusion coefficient of K₄Fe(CN)₆.

TABLE 2

| | | Free chlorine | Geometric |
|---|---|---|---|
| | Vₐₚₚ | generated | surface area:active |
| | (Volts) | (wtppm as Cl₂) | area |
| Electrode of Example 1 | 5 | 4.05 | 1:33 |
| Electrode of Example 2 | 5 | 7.65 | 1:51 |
| Electrode of Comparative | 5 | 2.86 | — |
| Example 1 | | | |
| Electrode of Comparative | 5 | 2.4 | 1:4.2 |
| Example 2 | | | |
| Electrode of Comparative | 5 | 3.7 | 1:1 |
| Example 4 | | | |
| Electrode of Comparative | 4 | 3.4 | 1:1 |
| Example 5 | | | |

Referring to Table 2, when using a chlorine-containing electrolyte, the electrodes prepared according to Examples 1 and 2 produced more free chlorine than the electrodes prepared according to Comparative Examples 1 to 2, the BBD electrode of Comparative Example 4, and the platinum electrode of Comparative Example 5. Also, the electrodes prepared according to Examples 1 and 2 had a geometric surface area to active area ratio which was more than 8 times greater than the ratio of geometric surface area to active area of the electrodes prepared according to Comparative Example 2, the BBD electrode of Comparative Example 4, and the platinum electrode of Comparative Example 5.

### Evaluation Example 2

### Cell Performance Evaluation

The cells prepared in Examples 1 and 2, and Comparative Examples 2 and 3 were each operated under the following conditions. After 20 minutes of the operation of the cells, samples of the treated water were collected and the amount of the microorganism contained in each sample was measured. Then, the amount of removed microorganism was calculated using the amounts of microorganism contained in water to be treated and in the samples of the treated water, and the results are shown in Table 3 below. In this regard, the amounts of microorganism contained in water to be treated and in the samples of the treated water were measured using a spread plate method. In the spread plate method, 0.1 milliliters (mL) of a sample containing a microorganism was spread on to a LB-Agar medium and cultured in an incubator at 37° C. for 18 hours. Then, the number of colonies of the microorganisms observed in the medium was counted and converted into the units colony forming units per milliliter (CFU/ml).

Each cell was operated at room temperature, while water to be treated was sufficiently supplied to the cell, e.g., the cell was substantially full of water to be treated.

A 200 mL quantity of hard water containing 10⁵ CFU/mL P. aeruginosa PA01 and having an ionic conductivity of 500 microsiemens per centimeter (μS/cm) was used as water to be treated. The hard water was continuously circulated at a flow rate of 25 milliliters per minute (mL/min) between the two electrodes of the cell.

A voltage of 5 V was applied between the two electrodes of the cell.

TABLE 3

| | | | Comparative | Comparative |
|---|---|---|---|---|
| | Example 1 | Example 2 | Example 2 | Example 3 |
| Microorganism | 99.979 | 99.999 | 98.8 | 99.6 |
| removal efficiency | | | | |
| (percent, %) | | | | |

Referring to Table 3, cells prepared according to Examples 1 and 2 have higher microorganism removal efficiencies than cells prepared according to Comparative Examples 2 and 3.

As described above, according to the one or more of the above embodiments, the electrode for electrochemical water treatment and the device for electrochemical water treatment including the electrode are provided. The electrode for electrochemical water treatment has a large active area due to high water permeability, has excellent microorganism-sterilizing capability for at least the reason that hypochlorite ions are generated when chlorine-containing water is treated, and may be manufactured without the use of a vapor deposition method, thereby reducing manufacturing cost. Also, the electrode may be formed to have a large area, have a wide potential window, have a high oxygen evolution overvoltage, and have high chemical stability, by including a nanodiamond.

It should be understood that the exemplary embodiments described therein should be considered in a descriptive sense only and not for purposes of limitation. Descriptions of features or aspects within each embodiment should be considered as available for other similar features or aspects in other embodiments.

What is claimed is:

1. An electrode for electrochemical water treatment, the electrode comprising:
a nanodiamond; and
a conducting agent.

2. The electrode of claim 1, wherein the nanodiamond has an average particle size equal to or less than about 10 nanometers.

3. The electrode of claim 1, wherein the conducting agent comprises at least one of carbon black or metallic powder.

4. The electrode of claim 3, wherein the metallic powder comprises at least one of chromium, tungsten, nickel, molybdenum, TiN, CrN, WN, NiN, MoN, TiC, CrC, WC, NiC, MoC, TiO, CrO, WO, NiO, or MoO.

5. The electrode of claim 1, wherein an amount of the conducting agent is about 10 weight percent to about 50 weight percent, based on a total weight of the nanodiamond and the conducting agent.

6. The electrode of claim 1, wherein an amount of the conducting agent is about 10 weight percent to about 50 weight percent, based on a total weight of the electrode.

7. The electrode of claim 1, wherein the electrode has a water-permeable three-dimensional structure.

8. The electrode of claim 7, wherein an active area of the electrode is greater than a geometric surface area of the electrode.

9. The electrode of claim 8, wherein an active area of the electrode is about 30 times greater than a geometric surface area of the electrode.

10. The electrode of claim 1, further comprising a binder.

11. The electrode of claim 10, wherein the binder comprises at least one of polyvinylidene fluoride, styrene butadiene rubber, carboxymethylcellulose, or polytetrafluoroethlyene.

12. A device for electrochemical water treatment, the device comprising an electrode for electrochemical water treatment, the electrode comprising:
a nanodiamond; and
a conducting agent.

13. A method of manufacturing an electrode, the method comprising:
detonating diamond to form nanodiamond; and
contacting the nanodiamond with a conducting agent.

14. The method of claim 13, wherein the nanodiamond has an average particle size of equal to or less than about 100 nanometers.

15. The method of claim 13, wherein the conducting agent comprises at least one of carbon black or metallic powder.

16. The method of claim 15, wherein the metallic powder comprises at least one of chromium, tungsten, nickel, molybdenum, TiN, CrN, WN, NiN, MoN, TiC, CrC, WC, NiC, MoC, TiO, CrO, WO, NiO, or MoO.

17. A method of treating water, the method comprising:
contacting an electrode and water, wherein the electrode comprises
a nanodiamond, and
a conducting agent.

18. The method of claim 17, wherein the nanodiamond has an average particle size of equal to or less than about 100 nanometers.

19. The method of claim 17, wherein the nanodiamond is ultra-dispersed-detonation diamond.

20. The method of claim 17, wherein the conducting agent comprises at least one of carbon black or metallic powder.

21. The method of claim 20, wherein the metallic powder comprises at least one of chromium, tungsten, nickel, molybdenum, TiN, CrN, WN, NiN, MoN, TiC, CrC, WC, NiC, MoC, TiO, CrO, WO, NiO, or MoO.
